(19) United States
(12) Patent Application Publication
(10) Pub. No.: US 2005/0198221 A1
(43) Pub. Date: Sep. 8, 2005

(54) Configuring an ad hoc wireless network using a portable media device

(75) Inventors: Scott Manchester, Redmond, WA (US); Benjamin Nick, Seattle, WA (US); Jean-Pierre Duplessis, Redmond, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/806,836

(22) Filed: Mar. 23, 2004

Related U.S. Application Data
(60) Provisional application No. 60/534,795, filed on Jan. 7, 2004.

(51) Int. Cl. G06F 15/177; G06F 15/173

(52) U.S. Cl. 709/220; 709/223

(57) ABSTRACT

A computer-readable portable media device is used for transferring network settings for an ad hoc wireless network to simply the task of configuring devices for the ad hoc wireless network. A configuration program on an initiating computer assists a user in creating the network settings, including a security key, and incorporates the network settings in an XML file and writes the file in to the portable media device. The portable media device is then attached to a second device that is to join the ad hoc wireless network. The second device is automatically configured using the network settings on the portable media device for joining the ad hoc wireless network.

### FIELD OF THE INVENTION

This invention pertains generally to the field of computer networks, and more particularly to a mechanism for simplifying the process of configuring nodes in a wireless computer network.

### BACKGROUND OF THE INVENTION

The use of data communication networks continues to grow. In small and large corporate settings, wired local area networks (LANs) and wide area networks (WANs) have become an established feature of conducting business, and wireless networks are being increasingly employed. The use of network technology in the home, both wired and wireless, is a more recent phenomenon and has been slower to develop. In addition to facilitating Internet connectivity, home networking permits personal computing devices and various consumer electronic devices and appliances within the home to communicate with each other. Wireless technology, such as IEEE 802.11 wireless networks and networks of Bluetooth-enabled devices, is attractive in home as well as corporate environments for reasons of convenience, mobility and flexibility.

A principal impediment to the wider adoption of networking technology in the home and other non-corporate environments has been the difficulty experienced by non-expert users in configuring network devices. This is especially the case for setting up a secure ad hoc wireless networks. In ad hoc wireless network, peer wireless devices (such as wireless PCs, tablets, wireless printers, PDAs, etc.) communicate directly with each other without the use of a wireless access point (AP) or a wired network. An ad hoc wireless is very useful in many scenarios, especially when an infrastructure wireless network is not available. For instance, an ad hoc wireless can be formed at a conference for the participants to exchange documents, on a bus or in a park for one-on-one file exchange, or in a home with friends for playing video games. To ensure the privacy of the wireless communications, a security key, such as a Wired Equivalent Privacy (WEP) key, is used by the participants of the ad hoc wireless network for the wireless communications.

Setting up an ad hoc wireless network is, however, typically a complex task. Each peer device must have the same network settings, and a secure ad hoc network typically requires each peer device to have a common WEP key, which must be communicated to the user of the peer device and entered manually. Entering the network settings and the WEP key onto each of the peer devices can be tedious and prone to errors. For instance, a long WEP key (e.g., 104-bit long) composed of random letters may enhance the security of the wireless transmissions. Such a long key, however, will be difficult to transfer by a user and time consuming and difficult to enter into machine that is to join the wireless network.

### BRIEF SUMMARY OF THE INVENTION

In accordance with the invention, a computer-readable portable media device, such as a USB flash drive or an SD memory card, is used to simplify the task of configuring network devices for setting up an ad hoc wireless network. A configuration application aids the user in generating, wireless configuration settings, and the network encryption key may be automatically generated so that a user does not have to enter a lengthy encryption key manually. The configuration application then generates an Extensible Markup Language (XML) file embodying the wireless network settings and writes that file to the portable media device. A user may then install the portable media device in one or more other network devices to automatically transfer the configuration settings to those network devices to configure each of the wireless devices. As a result, a wireless device may be provisioned with the wireless configuration settings necessary to join a wireless network, without requiring the user to manually enter the network settings.

Additional features and advantages of the invention will be apparent from the following detailed description of illustrative embodiments which proceeds with reference to the accompanying figures.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified schematic diagram illustrating an exemplary architecture of a computing device for carrying out the configuration of a computer network in accordance with an embodiment of the invention;

FIG. 2 is a schematic diagram illustrating an ad hoc wireless network established in accordance with a method of the invention;

FIG. 3 is a schematic diagram illustrating the use of a portable media device for transferring network settings for setting up a wireless device for joining an ad hoc wireless network;

FIGS. 4A-F are screenshots of a wizard application for generating network settings and storing the settings to a portable media device in accordance with an embodiment of the invention;

FIG. 5 is a schematic diagram illustrating a software architecture for carrying out the configuration of a computer network in accordance with an embodiment of the invention;

FIG. 6 is a flow diagram illustrating a method for creating an ad hoc network in accordance with an embodiment of the invention;

FIG. 7 is a process diagram illustrating a method for configuring a wireless access point in accordance with an embodiment of the invention; and

FIG. 8 is a schematic diagram showing a data structure having fields of an XML schema for representing wireless network configuration settings in accordance with an embodiment of the invention.

### DETAILED DESCRIPTION OF THE INVENTION

Methods and systems for configuring network devices for an ad hoc wireless network using a portable media device will now be described with respect to certain embodiments. The skilled artisan will readily appreciate that the methods and systems described herein are merely exemplary and that variations can be made without departing from the spirit and scope of the invention.

The present invention will be more completely understood through the following detailed description, which should be read in conjunction with the attached drawings. In this description, like numbers refer to similar elements within various embodiments of the present invention. The invention is illustrated as being implemented in a suitable computing environment. Although not required, the invention will be described in the general context of computer-executable instructions, such as procedures, being executed by a personal computer. Generally, procedures include program modules, routines, functions, programs, objects, components, data structures, etc. that perform particular tasks or implement particular abstract data types. Moreover, those skilled in the art will appreciate that the invention may be practiced with other computer system configurations, including hand-held devices, multi-processor systems, and microprocessor-based or programmable consumer electronics devices. The invention may also be practiced in distributed computing environments where tasks are performed by remote processing devices that are linked through a communications network. In a distributed computing environment, program modules may be located in both local and remote memory storage devices. The term computer system may be used to refer to a system of computers such as may be found in a distributed computing environment.

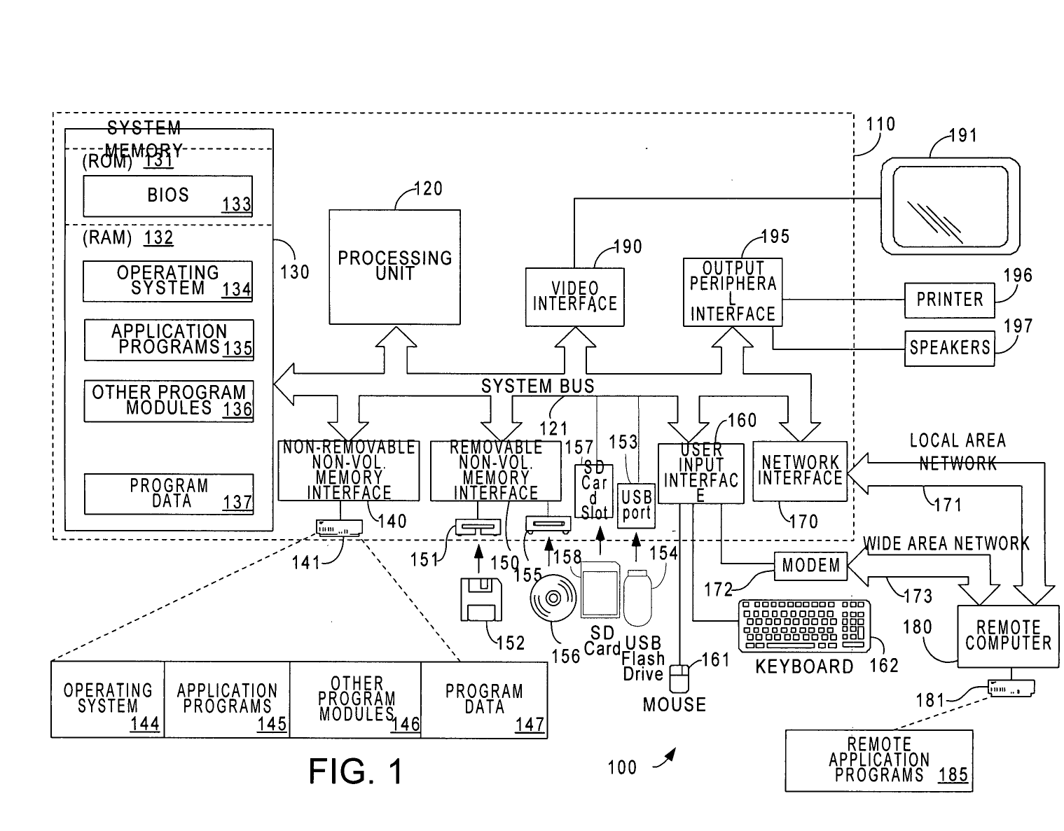

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100. Although at least one embodiment of the invention does include each component illustrated in the exemplary operating environment 100, another more typical embodiment of the invention excludes some or all non-essential components, for example, input/output devices other than those required for network communications.

With reference to FIG. 1, an exemplary system for implementing the invention includes a general purpose computing device in the form of a computer 110. Components of the computer 10 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

The computer 110 typically includes a variety of computer-readable media. Computer-readable media can be any available media that can be accessed by the computer 110 and includes both volatile and nonvolatile media, and removable and nonremovable media. By way of example, and not limitation, computer-readable media may comprise computer storage media and communication media. Computer storage media includes volatile and nonvolatile, removable and nonremovable media implemented in any method or technology for storage of information such as computer-readable instructions, data structures, program modules or other data. Computer storage media includes, but is not limited to, RAM, ROM, EEPROM, flash memory or other memory technology, optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above are included within the scope of computer-readable media.

The system memory 130 includes computer storage media in the form of volatile and/or nonvolatile memory such as read only memory (ROM) 131 and random access memory (RAM) 132. By way of example, and not limitation, FIG. 1 illustrates operating system 134, application programs 135, other program modules 136 and program data 137.

The computer 110 may also include other removable and nonremovable, volatile and nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CDROM. Other computer storage media that can be used in the exemplary operating environment include, but are not limited to, magnetic tape cassettes, flash memory cards, DVDs, digital video tape, solid state RAM, solid state ROM, and the like. The hard disk drive 141 is typically connected to the system bus 121 through a nonremovable memory interface such as interface 140, and magnetic disk drive 151 and optical disk drive 155 are typically connected to the system bus 121 by a removable memory interface, such as interface 150. The computer system may include of interfaces for additional types of removable non-volatile storage devices. For instance, the computer may have a USB port 153 that can accept a USB flash drive (UFD) 154, or a SD card slot 157 that can accept a Secure Digital (SD) memory card 158. A USB flash drive is a flash memory device that is fitted with a USB connector that can be inserted into a USB port on various computing devices. A SD memory card is a stamp-sized flash memory device. Both the USB flash drive and SD card offer high storage capacity in a small package and high data transfer rates. Other types of removable storage media may also be used for implementing the invention.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as a mouse, trackball or touch pad. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 by way of an interface, such as a video interface 190. The monitor 191 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 197 and printer 196, which may be connected through an output peripheral interface 194 or the like.

The computer 10 preferably operates or is adaptable to operate in a networked environment using logical connections to one or more remote computers, such as a remote computer 180. The remote computer 180 may be a personal computer, a server, a router, a peer device or other network node, and typically includes some or all of the elements described above relative to the computer 10, although only a memory storage device 181 has been illustrated in FIG. 1. The logical connections depicted in FIG. 1 include a LAN 171 and a WAN 173, but may also include other networks. For example, in the present invention, the computer 110 may comprise the source machine from which data is being migrated, and the remote computer 180 may comprise the destination machine. Note however that source and destination machines need not be initially connected by a network or otherwise, but instead, data may be migrated by way of any media capable of being written by the source platform and read by the destination platform or platforms. For example, one non-limiting instance of such a medium is a portable flash memory medium, sometimes referred to as a memory “key” or memory “stick.” Other non-limiting examples will be given below.

When used in a LAN environment, the computer 110 is connectable to the LAN 171 through a network interface or adapter 170. The computer 10 may also include a modem 172 or other means for establishing communications over the WAN 173. The modem 172, which may be internal or external, may be connected to the system bus 121 by way of the user input interface 160 or other appropriate mechanism. In a networked environment, program modules depicted relative to the computer 10, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

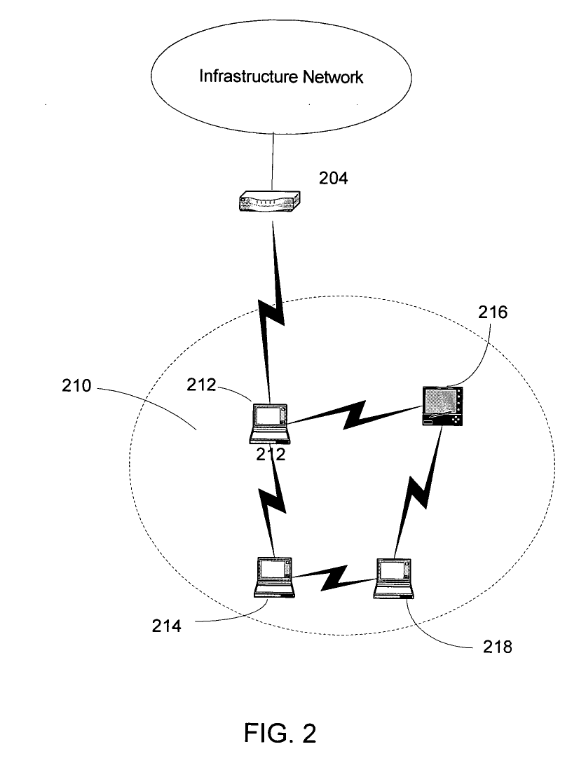

Turning to FIG. 2, the present invention is directed to a simple and convenient way for a user to set up a wireless ad hoc network, without having to go through the tedious and complex process of entering the network setting and security key into each of the wireless device joining the ad hoc network. As shown in FIG. 2, an ad hoc wireless network 210 may include a plurality of devices having the capability of wireless communications. The ad hoc wireless network 210 may include a variety of wireless communication protocols. Examples of suitable wireless communication protocols include wireless communication protocols in accordance with the Institute of Electrical and Electronics Engineers (IEEE) 802.1x series of standards, the Bluetooth® group of standards and the Ultra-Wideband (UWB) group of standards. The wireless devices may be of different types and having different levels of processing power. For instance, as shown in FIG. 2, the wireless devices include laptop (or notebook) PC's 212, 214, 216, a tablet computer 218. One of the wireless devices, such as the computer 212, in the ad hoc network may also communicate with an access point 204, thereby bridging the ad hoc wireless network with an infrastructure wireless network. In the ad hoc network 210, the wireless devices communicate with each other in a peer-to-peer fashion without the use of an access point. To form the ad hoc network 210, each wireless device has to be configured to have the settings and security key for the wireless network. Conventionally, setting up the wireless devices for participating in the ad hoc wireless network can be a very complex task, especially when a long security key has to be manually entered into each wireless device.

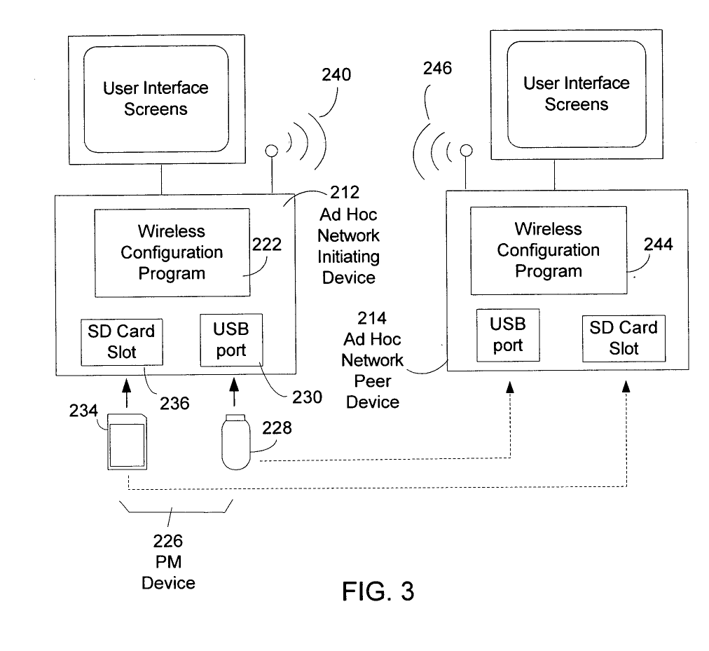

The present invention provides a way to establish a secure wireless ad hoc network that tremendously simplifies the task of setting up wireless devices for the network. Referring to FIG. 3, in accordance with the invention, a configuration program 222 on a first computer 212 is assists a user in generating the network settings and security key(s) for the wireless network. Once the settings are generated, they are stored on a portable media (PM) device 226 connected to the first computer 212. The portable media device may be, for example, a USB flash drive 228 that may be inserted into a USB port 230, or a SD memory card 234 that may be inserted into a SD card slot 236. It will be appreciated that the invention is not limited to these two portable memory media, and other types of portable memory media may be used for implementing the invention. For simplicity of illustration, the following description with describe an embodiment in which the portable media device used for setting up an ad hoc wireless device is a USB flash drive 228.

After the settings for the wireless network is stored on the portable media device 226, the portable media device is disconnected from the first computer 212 and used to transfer the wireless network settings to any other wireless device that wants to join the ad hoc wireless network. In a preferred embodiment, to set up a wireless device to join the wireless ad hoc network, all the user has to do is to connect the PORTABLE MEDIA to that wireless device, and the wireless network settings are automatically loaded into that device to enable it to start communicating with other wireless devices in the ad hoc wireless network. For example, in the example illustrated in FIG. 2, the settings for the wireless ad hoc network are defined on the first computer 212 and then transferred to the portable media device 226. The portable media device 226 is then connected to each of the notebook computers 214, 126, and the tablet computer 218 to transfer the network settings.

Referring back to FIG. 3, after the user has defined the network settings on the first computer, the wireless configuration program uses the settings to set up the first computer for the ad hoc network, and the first computer starts to transmit beacon signals 240 in the transmission band defined by the settings. When the portable media device 226 is connected to a second computer 214, the settings for the wireless ad hoc network are loaded into the second computer and used by a wireless configuration program 244 to set up the second computer to join the wireless network. After being configured for joining the wireless network 210, the second computer starts to send out beacon signals 246. Other computers accepting the portable media device 226 are similarly configured to communicate over the ad hoc wireless network 210. In this way, access to the ad hoc network 210 is generally limited to those computers that can physically attach the portable media device 226. Without the portable media device 226, a user would have to enter configuration settings—including the network name and any security keys—in order to access the wireless network 210. By attaching the portable media device 226, a computer is granted access to the wireless network 210 quickly and transparently.

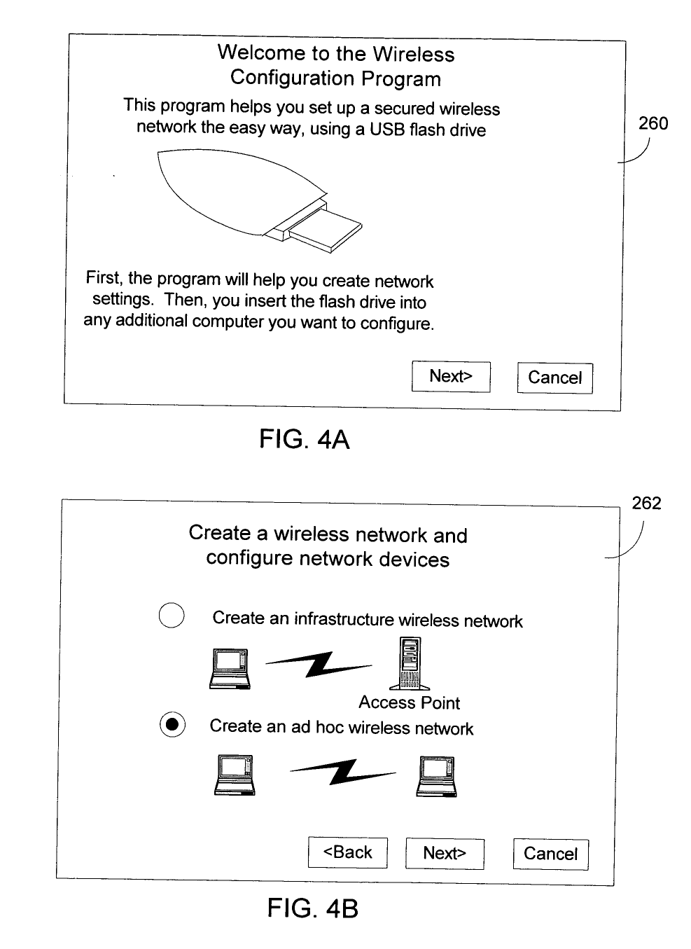

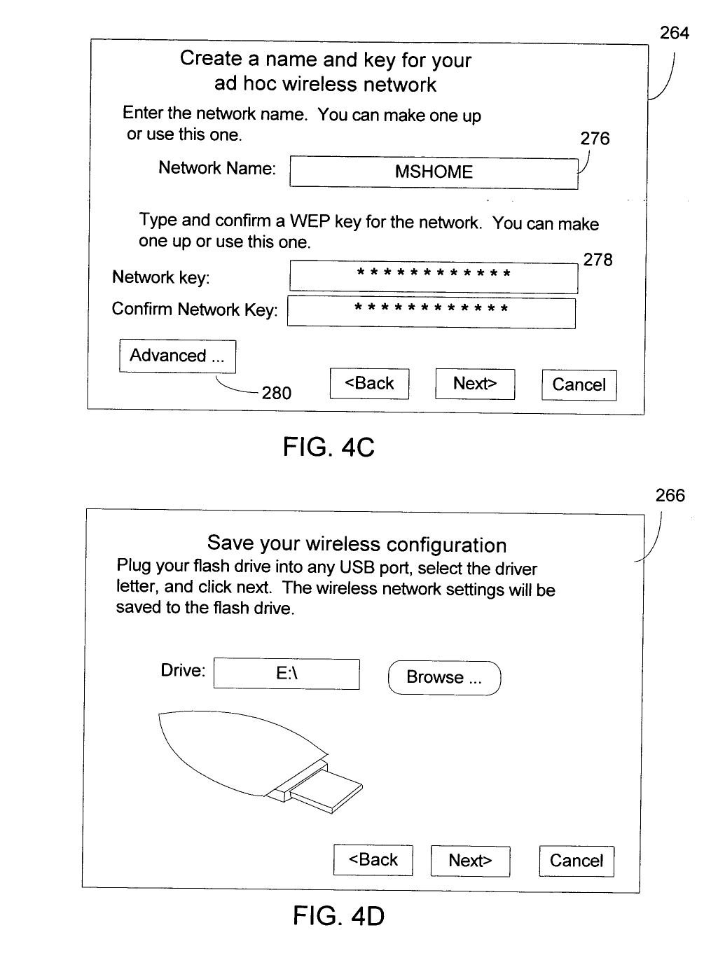

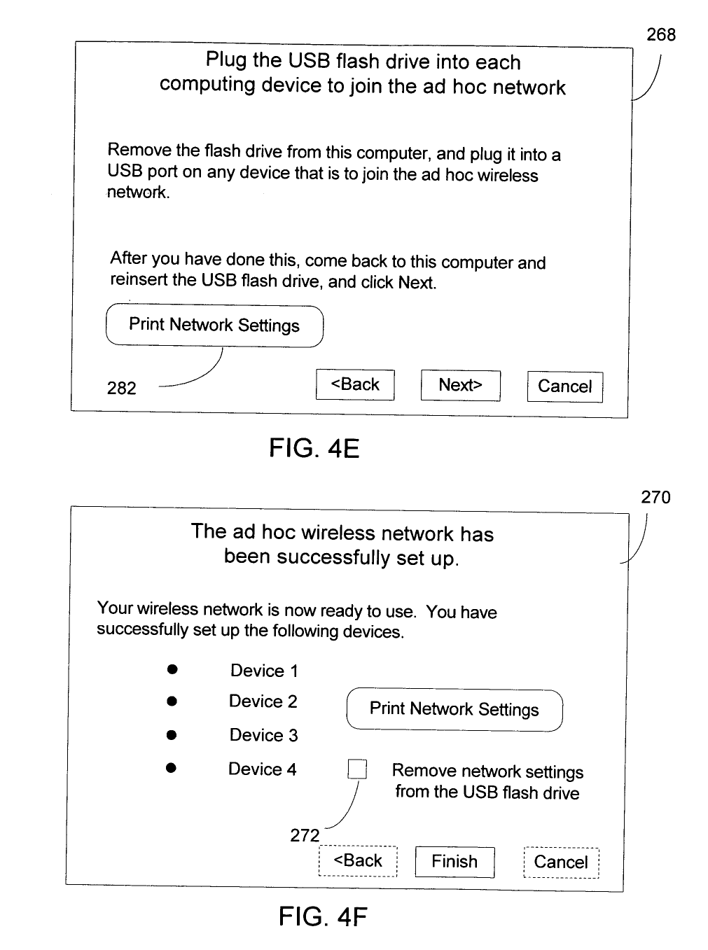

To further simply the task of setting up an ad hoc wireless network, the wireless configuration program provides a user interface to help a user to go through the steps of the process of defining the network settings and using the portable media device 226 to transfer the settings to other computers. Exemplary user interface screens are shown in FIGS. 4A-4F. For illustration purposes, the portable media device used in the example illustrated by these UI screens is a USB flash drive. In the user interface screen 260 illustrated in FIG. 4A, the user is informed that the configuration program will help the user create the settings for the wireless network, and then the settings will be saved on the USB flash drive and used to configure other computers or devices that are to join the wireless network. In the second UI screen 262 shown in FIG. 4B, the user are given the options of setting up an infrastructure wireless network and setting up an ad hoc wireless network, and the user selects to set up an ad hoc network.

In the UI screen 264 shown in FIG. 4C, the user is presented with a field 276 for selecting a name for the wireless ad hoc network, and a field 278 for selecting a network key. In one implementation, to minimize the work the user has to do, the configuration program may generate the network name and security key for the user, and the user may reject them and enter her own network name and key if she so desires. To that end, the name and key fields are initially filled by the wireless configuration program with values comprising either arbitrary data or data that is chosen using identifiers stored on the computer. For example, if the computer operating system has been registered to “John Smith”, then the wireless configuration program can generate “JohnSmithsNetwork” as the default network name. The wireless configuration program may call a function of the operating system to generate a security key for the wireless network. The user can accept the network name and key suggested by the configuration program by clicking “Next”, or can edit the fields manually. Additionally, by clicking an “Advanced” button 280, the user is permitted to edit a variety of other network configuration settings, which otherwise are automatically generated by the wireless configuration program. An advantage of providing a key generated by the computer is that the key is a full-sized key containing randomized letters. Such a key may provide enhanced security as compared to a user-entered key, which tends to be short and contain patterns that are easy for the user to memorize. Since the network settings, including the security key, are to be transferred to other computers by means of the portable media device, the user does not have try to create a key that she can remember and is more likely to use the key generated by the computer.

In the UI screen 266 shown in FIG. 4D, the wireless configuration program prompts the user to insert and identify a USB flash drive. When the user clicks “Next” on this screen to indicate that the USB flash drive has been inserted, the wireless configuration program stores the generated network settings for the wireless ad hoc network to the USB flash drive.

When the network settings have been completely stored on the USB flash drive, the user is presented with another UI screen 268 shown in FIG. 4E, prompting the user to remove the portable media device and plug it into all additional computing devices that are to join the ad hoc network. The UI screen 268 also presents the user with a “Print” button 282, allowing the user to print a hard copy of the network settings, which allows the user to manually configure those network devices that do not accept the portable media device or that cannot be automatically configured for the network.

When the user uses the USB flash drive to set up another computing device for the wireless network, the settings established on that device are written back onto the USB flash drive. After the user has used the USB flash drive to set up other computing devices for the ad hoc wireless network, she returns to the first computer 212 and inserts the USB flash drive in a USB port of the computer. The configuration program reads the setting data written by the other devices and presents a UI screen 270 as shown in FIG. 4F. The UI screen 270 identifies the devices that have been successfully set up for the wireless network. In addition, the configuration program presents the option of removing the settings from the USB flash drive. This prevents the network settings being inadvertently revealed to others when the USB flash drive is later used to transfer data to other computers. Since some users may have the tendency to use the same network name or key, this option of removing the network settings is provided to provide enhanced security.

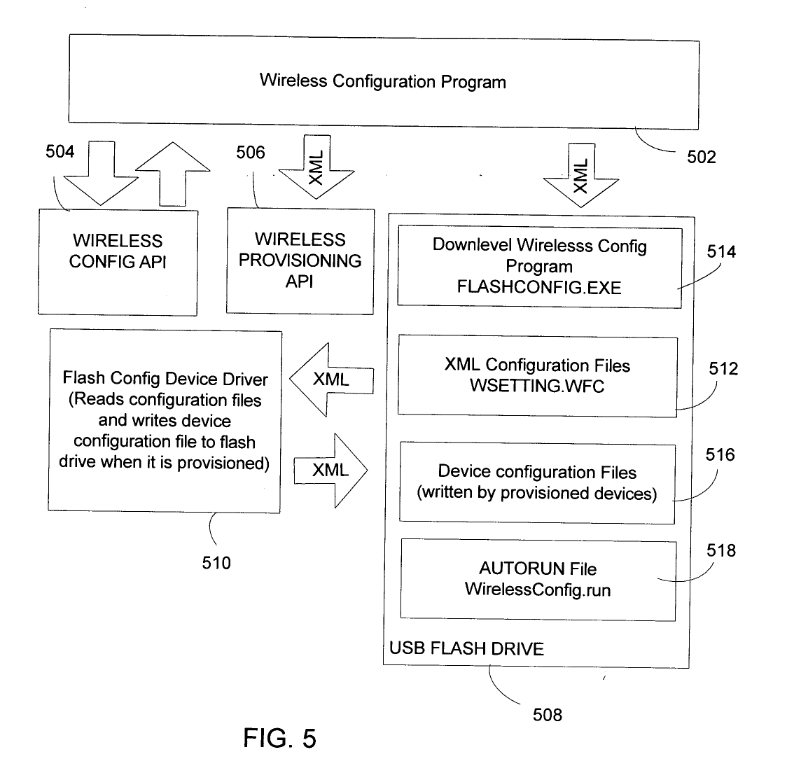

Turning now to FIG. 5, a software architecture used in an embodiment of the invention for generating and storing wireless network configuration settings is now described. A wireless configuration program 502 is executed on a computer and communicates with the computer through a wireless configuration application programming interface (API) 504 to generate wireless network configuration settings. In the Windows operating system environment of Microsoft Corporation, for example, the WZCDLG.DLL library can be used.

In accordance with a feature of the embodiment, the network settings for the wireless ad hoc network are stored in the format of an Extensible Markup Language (XML) file. The use of an XML file presents a standard format that can be recognized by many different devices. The wireless configuration program 502 outputs the XML files to the computer through a wireless provisioning API 506. The wireless configuration program 502 further outputs XML files for writing into an attached portable media device, such as a USB flash drive 508. To that end, a flash configuration device driver 510 reads configuration files and writes a device configuration file to the USB flash drive when it is provisioned.

The configuration program stores several files on the USB flash drive 508 for use in the network configuration process. In the embodiment illustrated in FIG. 5, the files include the XML files representing the generated network configuration settings. In one implementation, the XML files containing the network settings are give a special extension name such as “wfc” as shown in FIG. 5, to indicate that the files contain wireless configuration settings. Thus, when the USB flash drive is plugged into another computing device, the operating system of that device will recognize the files as containing wireless network setup information and will invoke the wireless configuration program on that device to handle the files. In addition, a network setup application 510 (called “Downlevel Flash Config Wizard” in FIG. 5) may be stored on the USB flash drive 508 in order to facilitate the configuring of network settings for other devices. When the USB flash drive 508 is attached to another device, that device can run the network setup application to load the relevant network settings from the USB flash drive 508 to the other device. As also shown in FIG. 5, the USB flash drive 508 may be used to store device configuration files 516 that are written into the flash drive by devices that provisioned for the wireless network using the flash drive. In one implementation, each device configuration file is identified by a file name that contains the last 8 bytes of the MAC address of the provisioned device in ASCII-HEX format. This file name allows the computer on which the network settings are created to identify the provisioned device.

In an embodiment of the invention, the USB flash drive 508 further stores an autorun file, such as wireless.cfg 518. When the USB flash drive 508 is attached to a compatible device that recognizes the autorun file, the detection of wireless.cfg 518 automatically triggers the device to execute the network setup program 510. In this way, no user intervention is required to transfer the network settings to the device after the USB flash drive 508 has been attached.

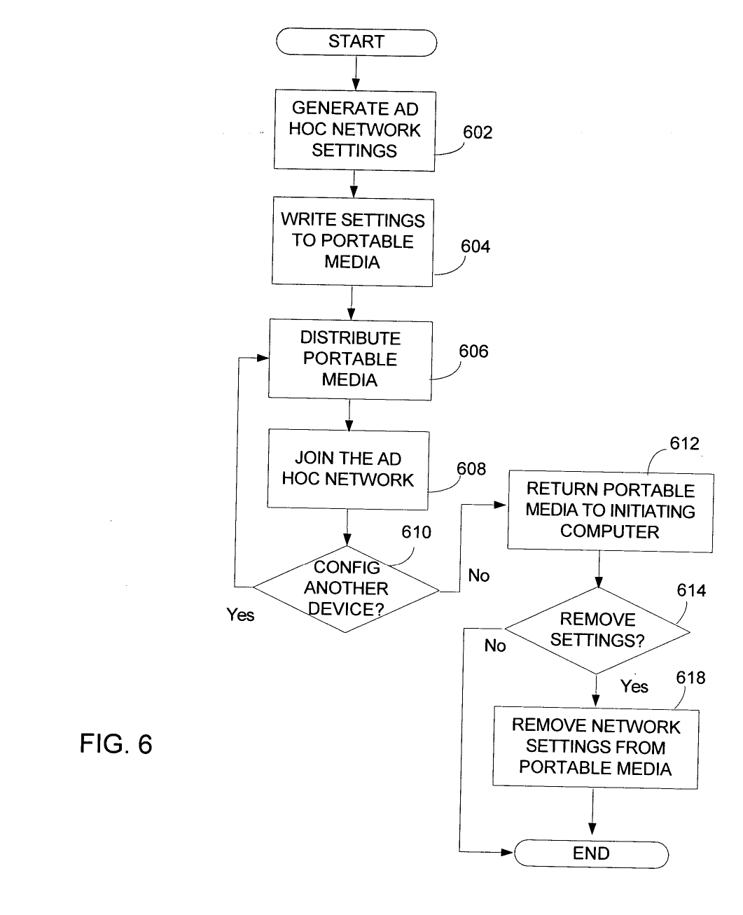

A method for using a portable media device to transfer network configuration settings to other devices for setting up an ad hoc wireless network in accordance with an embodiment of the invention is now described with reference to FIG. 6. An ad hoc network generally is of temporary duration and geography, for example, at an afternoon meeting of ten people in a conference room, or between two people on an airplane. The described method does not require users to know or enter either the name of the network or a security key, and it facilitates efficient creation of ad hoc networks. The method begins with generating network settings on an initiating computer for the ad hoc network at step 602. The network settings preferably include a Name string used to identify the network, such as an SSID string used during the 802.11 beaconing process, and a Pre-Shared Key string used for network authentication. Authentication types could include, for example, WEP, WPA PSK, or 802.11i PSK encryption. The key format could be a binary or hexadecimal number, an alphanumeric string, or a keyword.

The settings are stored on a Portable media device, such as a USB flash drive, at step 604, using an XML schema or other suitable data format. XML provides a standard format for storing data such that devices of different manufacturers have a consistent way of parsing and consuming the data required in order to join the ad hoc network. By generating a large security key (such as a WEP key of 104 bits), the network settings stored on the PORTABLE MEDIA DEVICE can ensure that the ad hoc network is secure. The portable media device is then removed from the initiating computer and distributed to another device at step 606, which is set up and added to the ad hoc network at step 608 by attaching the portable media device to it. The device being provisioned uploads the stored network settings from the portable media device, selects the appropriate network, and performs necessary activities to participate in the ad hoc network, such as authentication and encryption. The provisioned device may also write its configuration data as a configuration log file 516 (see FIG. 5) onto the portable media device. In one embodiment, previously uploaded configuration settings are stored as multiple profiles. By using profiles, users can easily revert to previous network settings and switch to other networks without needing to obtain the network configuration settings again. The method continues with users deciding whether an additional device, such as a printer or another user's computer, is to be added to the ad hoc network at step 610. If so, the portable media device is distributed to the new device at step 606, which then joins the network at step 608. Any number of devices can be added to the ad hoc network in this manner. When all the devices joining the ad hoc wireless network have been configured, the portable media device is returned to the initiating computer at step 612.

The configuration program on the initiating computer retrieves the configuration files of the provisioned devices from the portable media, and may display the settings of the provisioned devices for viewing by the user. In addition, the configuration program presents the option of removing the settings from the USB flash drive at step 614. In the UI screen 270 of FIG. 4F, this option is presented as a check box 272. If the user chooses that option, the configuration program deletes the network settings and the configuration log files from the portable media device at step 618. This prevents the network settings being inadvertently revealed to others when the USB flash drive is later used to transfer data to other computers. Since some users may have the tendency to use the same network name or key, this option of removing the network settings is provided to provide enhanced security. Additional enhanced security measures may be incorporated into configuration methods such as the method described with reference to FIG. 6. For example, utilizing conventional cryptographic techniques, some or all of the settings stored on the portable media device may be encrypted and then require suitable authentication information before being decrypted and/or allow decryption a particular number of times or within a particular date range. Examples of suitable authentication information include a personal identification number (PIN), a password, a pass-phrase and suitable biometrics such as a thumbprint.

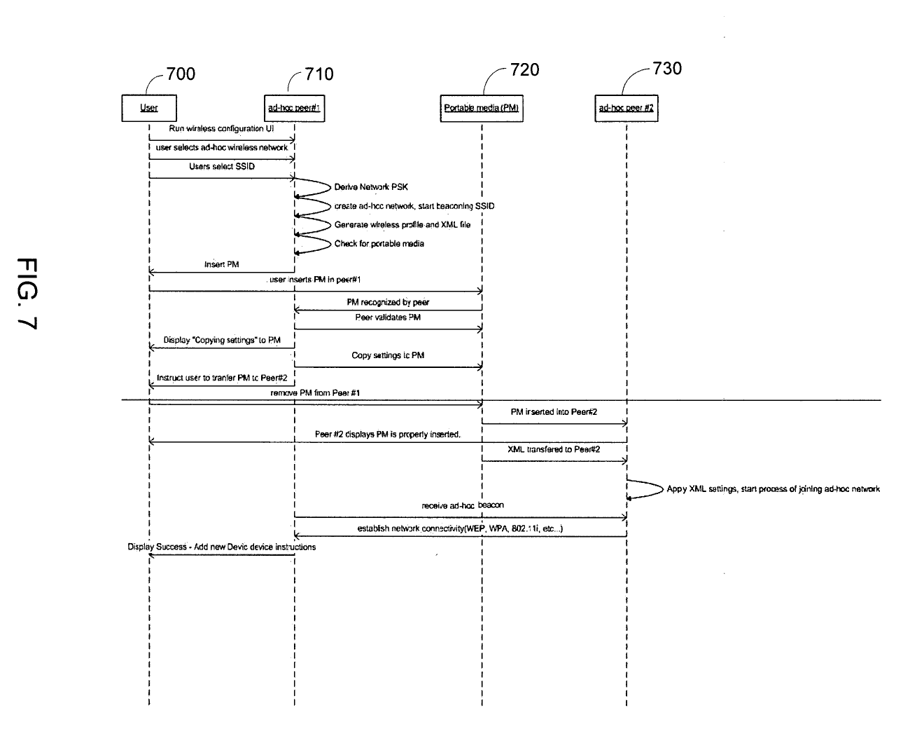

FIG. 7 presents an exemplary sequence of actions illustrating the generating and transferring of network configuration settings, by way of a portable media device, in order to create an ad hoc network. As illustrated in FIG. 7, a user 700 interacts with an initiating computer 710 to create the network settings. The settings are stored on a portable media device 720 as files in the XML format. The portable media device 720 is then used to configure another peer device of the wireless ad hoc network.

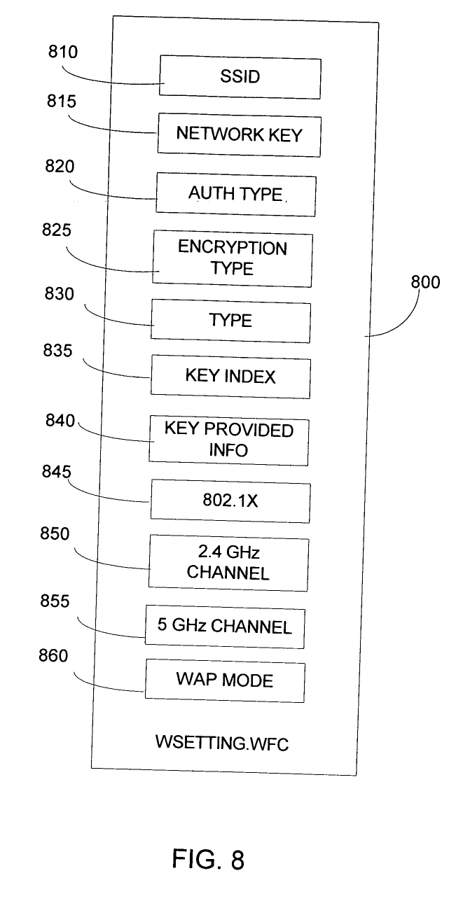

FIG. 8 illustrates a conceptualization of a schema 800 corresponding to the XML file used in an embodiment for storing the ad hoc wireless network settings on the portable media device. Each element of schema 800 represents a wireless configuration setting. Service set identifier (SSID) 810 is a 1-32 byte string representing the name of the wireless network. SSID 810 can only occur once. Network Key 815 is a string that the PC will automatically generate, or alternatively, receive from the PC user. The Network Key 815 is used for encryption on the wireless network. Authentication Type 820 indicates the authentication protocol used by the wireless network. Authentication Type 820 allows a range of possible values, including open, shared, WiFi Protected Access (WPA), WPA Pre-Shared Key (PSK), WPA-none, WPA2, or WPA2 PSK. Encryption Type 825 indicates the encryption protocol used by the wireless network. Encryption Type 825 allows a range of possible values, including none, Wireless Encryption Protocol (WEP), Temporal Key Integrity Protocol (TKIP), and Advanced Encryption Standard (AES).

Type 830 indicates a connection type, and may have as its value either extended service set (ESS) in the case of an ad hoc network, or infrastructure basic service set (IBSS) in the case of an infrastructure network. Key Index 835 indicates the location of the specific key used to encrypt messages, and may have a value of 1, 2, 3, or 4. Key Index 835 is used with WEP. Key Provided Info 840 indicates whether a key is provided automatically, and can have a value of either 0 or 1. 802.1X 845 indicates whether IEEE 802.1X protocol is used on the network, and can have a value of either 0 or 1. 2.4 GHz Channel 850 indicates which 2.4 GHz Channel, if any, is being used by the wireless network, and can have a value in the range of 1 to 14. 5 GHz Channel 855 indicates which 5 GHz channel, if any, is being used by the wireless network, and can have a value of 36, 40, 44, 48, 52, 56, 60, 64, 149, 153, 157, or 161. WAP Mode 860 indicates the mode in which the wireless access point is operating. WAP Mode 860 can have a value of infrastructure, bridge, repeater, or station.

An exemplary XML schema is as follows:

<?xml version=“1.0” encoding=“utf-8” ?>

<xs:schema xmlns:xs=“http://www.w3.org/2001/XMLSchema”
targetNamespace=“http://www.microsoft.com/provisioning/WirelessProfile/2004”

xmlns=“http://www.microsoft.com/provisioning/WirelessProfile/2004”

elementFormDefault=“qualified”
version=“1”>

<xs:element name=“wirelessProfile”>

<xs:complexType>

<xs:sequence>

<xs:element name=“config”>

<xs:complexType>

<xs:sequence>

<xs:element name=“configId” minOccurs=“1” maxOccurs=“1”>

<xs:simpleType>

<xs:restriction base=“xs:string”>

<xs:length value=“36” />

</xs:restriction>

</xs:simpleType>

</xs:element>
<xs:element name=“configHash” minOccurs=“0” maxOccurs=“1”>

<xs:simpleType>

<xs:restriction base=“xs:hexBinary”>

<xs:length value=“40” />

</xs:restriction>

</xs:simpleType>

</xs:element>
<xs:element name=“configAuthorId” minOccurs=“1” maxOccurs=“1”>

<xs:simpleType>

<xs:restriction base=“xs:string”>

<xs:length value=“36” />

</xs:restriction>

</xs:simpleType>

</xs:element>
<xs:element name=“configAuthor” minOccurs=“1” maxOccurs=“1”>

<xs:simpleType>

<xs:restriction base=“xs:string”>
<xs:maxLength value=“128” />

</xs:restriction>

</xs:simpleType>

</xs:element>

</xs:sequence>

</xs:complexType>

</xs:element>
<xs:element name=“ssid” minOccurs=“1” maxOccurs=“1”>

<xs:simpleType>

<xs:restriction base=“xs:string”>

<xs:maxLength value=“32” />

</xs:restriction>

</xs:simpleType>

</xs:element>
<xs:element name=“connectionType” minOccurs=“1” maxOccurs=“1”>

<xs:simpleType>

<xs:restriction base=“xs:string”>

<xs:enumeration value=“IBSS” />
<xs:enumeration value=“ESS” />

</xs:restriction>

</xs:simpleType>

</xs:element>
<xs:element name=“channel2Dot4” type=“xs:integer” minOccurs=“0” maxOccurs=“1” />
<xs:element name=“channel5Dot0” type=“xs:integer” minOccurs=“0” maxOccurs=“1” />
<xs:element name=“deviceMode” minOccurs=“0” maxOccurs=“1”>

<xs:simpleType>

<xs:restriction base=“xs:string”>

<xs:enumeration value=“infrastructure” />
<xs:enumeration value=“bridge” />
<xs:enumeration value=“repeater” />
<xs:enumeration value=“station” />

</xs:restriction>

</xs:simpleType>

</xs:element>
<xs:element name=“primaryProfile” type=“profileInstance” minOccurs=“1” maxOccurs=“1” />

<xs:element name=“optionalProfile” type=“profileInstance” minOccurs=“0”

maxOccurs=“unbounded” />

</xs:sequence>

</xs:complexType>

</xs:element>
<xs:complexType name=“profileInstance”>

<xs:sequence>

<xs:element name=“authentication” minOccurs=“1” maxOccurs=“1”>

<xs:simpleType>

<xs:restriction base=“xs:string”>

<xs:enumeration value=“open” />
<xs:enumeration value=“shared” />
<xs:enumeration value=“WPA-NONE” />
<xs:enumeration value=“WPA” />
<xs:enumeration value=“WPAPSK” />
<xs:enumeration value=“WPA2” />
<xs:enumeration value=“WPA2PSK” />

</xs:restriction>

</xs:simpleType>

</xs:element>
<xs:element name=“encryption” minOccurs=“1” maxOccurs=“1”>

<xs:simpleType>

<xs:restriction base=“xs:string”>

<xs:enumeration value=“none” />
<xs:enumeration value=“WEP” />
<xs:enumeration value=“TKIP” />
<xs:enumeration value=“AES” />

</xs:restriction>

</xs:simpleType>

</xs:element>
<xs:element name=“networkKey” minOccurs=“1” maxOccurs=“1”>

<xs:simpleType>

<xs:restriction base=“xs:string”>

<xs:maxLength value=“64” />

</xs:restriction>

</xs:simpleType>

</xs:element>
<xs:element name=“keyIndex” type=“xs:integer” minOccurs=“0” maxOccurs=“1” />
<xs:element name=“keyProvidedAutomatically” type=“xs:boolean” minOccurs=“1” maxOccurs=“1”
/>
<xs:element name=“ieee802Dot1xEnabled” type=“xs:boolean” minOccurs=“1” maxOccurs=“1” />

</xs:sequence>

</xs:complexType>

</xs:schema>

An exemplary instance of a WSETTINGS.XML file is set forth below. This instance was generated, for example, by the PC using the wireless configuration XML schema set forth immediately above.

<?xml version=“1.0” ?>

<WirelessProfile

xmlns=“http://www.microsoft.com/provisioning/WirelessProfile”>

<ssid>HOMENET</ssid>
<ConnectionType>ESS</ConnectionType>
<Authentication>WPAPSK</Authentication>
<Encryption>TKIP</Encryption>
<NetworkKey>WirelessKey!0</NetworkKey>
<KeyProvidedAutomatically>0</KeyProvidedAutomatically >
<IEEE802.1Xenabled>0</IEEE802.1Xenabled>

</WirelessProfile>

It will be appreciated that an improved system and method for wireless network device configuration have been disclosed herein. In view of the many possible embodiments to which the principles of the present invention may be applied, it should be recognized that the embodiments described herein with respect to the drawing figures are meant to be illustrative only and should not be taken as limiting the scope of the invention. For example, those of skill in the art will recognize that the illustrated embodiments can be modified in arrangement and detail without departing from the spirit of the invention. Although the invention is described in terms of software modules or components, those skilled in the art will recognize that such may be equivalently replaced by hardware components. Therefore, the invention as described herein contemplates all such embodiments as may come within the scope of the following claims and equivalents thereof.

1. A computer-readable medium having computer-executable instructions for performing steps for configuring wireless devices for forming an ad hoc wireless network, comprising:
prompting a user, through a user interface of an initiating computer, to create network settings for the ad hoc wireless network;
collecting network settings for the ad hoc wireless network;
generating an Extensible Markup Language (XML) file including the network settings for the ad hoc wireless network;
writing the XML file to a portable media device connected to the initiating computer; and
instructing the user, through the user interface, to remove the portable media device from the initiating computer and to connect the portable media device to a peer computing device for configuring the peer computing device for joining the ad hoc wireless network.

2. A computer-readable medium as in claim 1, wherein the step of collecting network settings includes generating, by the initiating computer, default values for selected network settings.

3. A computer-readable medium as in claim 2, wherein the step of generating default values includes invoking an application program interface (API) of an operating system of the initiating computer to generate the default values for the selected network settings.

4. A computer-readable medium as in claim 2, wherein the step of collecting network settings includes generating a security key for the ad hoc wireless network.

5. A computer-readable medium as in claim 1, wherein the step collecting network settings includes receiving network setting data entered by the user.

6. A computer-readable medium as in claim 1, wherein the portable media device is a universal serial bus (USB) flash drive.

7. A computer-readable medium as in claim 1, wherein the portable media device is a flash memory card.

8. A computer-readable medium as in claim 1, having further computer-executable instructions for performing steps of:
detecting reconnection of the portable media device to the initiating computer; and
retrieving by the initiating computer configuration data written by the peer computing device into the portable media device in connection with configuring the peer computing device for joining the ad hoc wireless network.

9. A portable media device for provisioning a computing device with network settings, the portable media device having stored thereon data comprising:
an XML file containing network settings for setting up the computing device to join an ad hoc wireless network when the portable media device is connected to the computing device.

10. A portable media device as in claim 9, wherein the data stored on the portable media device further include an autorun file for prompting the computing device to automatically apply the network settings configuration.

11. A portable media device as in claim 9, wherein the portable media device is a universal serial bus (USB) flash drive.

12. A portable media device as in claim 9, where the portable media device is a flash memory card.

13. A portable media device as in claim 9, wherein the network settings include a network name and a network security key for the ad hoc wireless network.

14. A portable media device as in claim 9, further comprising a network configuration application to be executed for configuring the computing device when the portable media device is connected to the computing device.

15. A method of provisioning a wireless computing device with network settings for joining an ad hoc wireless network, comprising:
determining network settings for the ad hoc wireless network, the network settings including a network name and a network security key for the ad hoc wireless network;
generating an Extensible Markup Language (XML) file including the network settings for the ad hoc wireless network; and
writing the XML file to a portable media device, wherein the steps of determining, generating, and writing are performed on an initiating computer of the ad hoc wireless network.

16. A method as in claim 15, further including the steps of:
connecting the portable media device to the computing device to be provisioned; and
executing a configuration program on the computing device to automatically configure the computing device using the network settings in the XML file on the portable media device.

17. A method as in claim 15, wherein the step of determining includes generating by the initiating computer a network security key for the ad hoc wireless network.

18. A method as in claim 15, wherein the step of determining includes prompting a user to enter a network security key for the ad hoc wireless network.

19. A method as in claim 15, wherein the step of determining includes invoking an application program interface (API) of an operating system of the initiating computer to provide the network settings.

20. A method as in claim 15, wherein the portable media device is a universal serial bus (USB) flash drive.

21. A method as in claim 15, wherein the portable media device is a flash memory card.

22. A computer-readable medium having computer-executable instructions for performing steps for configuring a computing device for joining an ad hoc wireless network, comprising:
detecting installation of a portable media device on the computing device, the portable media device containing network settings for the ad hoc wireless network; and
automatically configuring the computing device for joining the ad hoc wireless network using the network settings contained in the portable media device.

23. A computer-readable medium as in claim 22, wherein the step of automatically configuring includes recognizing that the portable media device contains network settings, and invoking a configuration program to implement the network settings in the computing device.

24. A computer-readable medium as in claim 22, having further computer-executable instructions for performing the step of writing network settings configured on the computing device into the portable media device.

25. A computer-readable medium as in claim 22, wherein the portable media device is a universal serial bus (USB) flash drive.

26. A computer-readable medium as in claim 22, wherein the portable media device is a flash memory card.

27. A method of configuring a computing device for joining an ad hoc wireless network, comprising:
detecting installation of a portable media device on the computing device, the portable media device containing network settings for the ad hoc wireless network; and
automatically configuring the computing device for joining the ad hoc wireless network using the network settings contained in the portable media device.

28. A method as in claim 27, wherein the step of automatically configuring includes recognizing that the portable media device contains network settings, and invoking a configuration program to implement the network settings in the computing device.

29. A method as in claim 27, further including the step of writing network settings configured on the computing device into the portable media device.

30. A method as in claim 27, wherein the portable media device is a universal serial bus (USB) flash drive.

31. A method as in claim 27, wherein the portable media device is a flash memory card.
